(19) United States
(12) Patent Application Publication
(10) Pub. No.: US 2022/0245728 A1
(43) Pub. Date: Aug. 4, 2022

(54) SYSTEM FOR EVALUATING AND REPLICATING ACTURIAL CALCULATION PATTERNS USING NEURAL IMAGING AND METHOD THEREOF

(71) Applicant: Fergal MCGUINNESS, Rapperswil (CH)

(72) Inventor: Fergal MCGUINNESS, Rapperswil (CH)

(21) Appl. No.: 17/597,136

(22) PCT Filed: Jun. 24, 2019
(86) PCT No.: PCT/IB2019/055306

§ 371 Date: Dec. 27, 2021

(51) Int. Cl. G06Q 40/08; G06N 3/08

(52) U.S. Cl. CPC G06Q 40/08; G06N 3/08

(57) ABSTRACT

The present invention relates to a system and method for training an artificial intelligence (AI) based neural imaging system for evaluating and replicating actuarial calculation patterns of known valuation systems. In particular, present inventions disclose evaluating, using neural imager, output from a data generation unit and output from the actuarial assumption generation unit with the output from a valuation system to generate at least an image model replicating the actuarial calculations of the valuation system using neural networks.

### TECHNICAL FIELD

The present disclosure generally relates to an artificial intelligence (AI) based neural imaging system for evaluating and replicating actuarial calculation patterns. Particularly, the present invention relates to a system and method that evaluates actuarial calculation of a bespoke actuarial model and replicates said actuarial calculations for future processing.

### BACKGROUND OF THE DISCLOSURE

Insurance industry is an industry which has not made any significant development, till date, in terms of providing technical means by which an insurer/investor may be able to evaluate the risk before making the investment. Typically, an insurer manages multiple of portfolios of distinct risks made up of difference coverage types and/or geographies. Developing an understanding of the specifics of any one of these portfolios is very difficult, even when dealing with an insurer willing to disclose that detail. To develop a thorough understanding, an investor needs access to the complex (often proprietary) actuarial software as well as the expert team that set it up.

These modern risk management techniques (i.e. actuarial software's) often require that a valuation software run thousands of simulations of both economic and demographic scenarios to quantity underlying risks. Also, some of these legacy valuation systems are designed on old architectures that make it impossible for them to complete these calculations is a timely fashion. Furthermore, these legacy valuation systems are operated by highly trained professionals experienced in both customizing the software application and actuarial model being programmed. Thus, given the expense in giving this kind of access, it rarely is given with investors being forced to rely on aggregated figures.

Therefore, there exists a need for a technology without the requirement of a person to have detailed knowledge of the actuarial software applications. Moreover, a technology that enables a consistent approach to both set-up and execution to allow for coordination across heterogeneous operating models. Furthermore, insurers looking to avoid the high costs associated with replacing legacy systems, need a mechanism to complete complex simulations, keeping the legacy system in place.

### SUMMARY OF THE DISCLOSURE

Before the present method, system and hardware are described, it is to be understood that this invention is not limited to the particular systems and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention which will be limited only by the appended claims.

In first embodiment, the present disclosure describes an artificial intelligence (AI) based neural imaging system configured to evaluate and replicate actuarial calculation patterns. Said system comprising a data generation unit configured to generate a first output, in response to random data provided for an actuarial assessment, the first output being in a first format and an actuarial assumption generation unit configured to generate a second output, in response to at least one of demographic and economic assumptions, the second output being in the first format. Further, the system comprises a valuation system that is configured to receive the first output and the second output, as inputs, via a valuation system interface, to perform actuarial calculations on the first output and the second output and provide a third output, in response to said calculations, said output being in a second format, wherein the first format is different than the second format. Said system further comprises a neural imager configured to receive the first, the second and the third output, as inputs, and evaluate the first and the second outputs with the third output to generate at least one image replicating the actuarial calculation patterns of said valuation system, wherein said evaluation involves performing iterations, on the first and the second outputs, until the generated image is within pre-defined tolerance level. The neural imager of said system is further configured to store the generated image for future evaluations.

In another embodiment, the present disclosure discloses having a first data conversion unit coupled to the data generation unit and the actuarial assumption generation unit, the first data conversion unit being configured to convert the first output and the second output in a third format different than the first format. The system further discloses having a second data conversion unit coupled to the valuation system, the second data conversion unit being configured to convert the third output in the third format different than the second format, wherein the third format is a format readable by the neural imager.

In another embodiment, the present disclosure describes that the neural imager receives the first output and the second output, as inputs, via the first data conversion unit.

In another embodiment, the present disclosure describes that the neural imager receives the third output, as input, via the second data conversion unit.

In another embodiment, the present disclosure describes having one or more valuation systems, wherein each of said valuation systems is capable of interacting with the neural imager at a time.

In another embodiment, the present disclosure describes that said system is applicable for at least one of establishment of consensus actuarial models, risk securitization, risk trading, accelerating asset liability modelling, calculating reserves, projecting cashflows, pricing risk, liability matching and integrating actuarial systems.

In second embodiment, the present disclosure describes a method of training an artificial intelligence (AI) based neural imaging system for evaluating and replicating actuarial calculation patterns. Said method discloses generating a first output, in response to random data provided for an actuarial assessment, wherein the first output being in a first format, generating a second output, in response to at least one of demographic and economic assumptions, wherein the second output being in the first format. The method further discloses receiving the first output and the second output, as inputs, at a valuation system via a valuation system interface and performing at the valuation system, actuarial calculations on the first output and the second output. In the subsequent steps the method discloses providing by the valuation system, a third output, in response to said calculations, wherein said output being in a second format, and the first format is different than the second format, receiving at a neural imager, the first, the second and the third output, as inputs, and evaluating at the neural imager, the first and the second outputs with the third output to generate at least one image replicating the actuarial calculation patterns of said valuation system, wherein said evaluation involves performing iterations, on the first and the second outputs, until the generated image is within pre-defined tolerance level. Once, the evaluation is completed the method discloses the step of storing the generated image for future evaluations.

In another embodiment, the present disclosure describes converting the first output and the second output in a third format different than the first format and converting the third output in the third format different than the second format, wherein the third format is a format acceptable to the neural imager.

In another embodiment, the present disclosure describes that the first output, the second output and the third output are received, as inputs, by the neural imager in the third format.

In another embodiment, the present disclosure describes that said method may be is performed with one or more valuation systems, wherein each of said valuation systems is capable of interacting with the neural imager at a time.

In another embodiment, the present disclosure describes that said method is applied in at least one of establishment of consensus actuarial models, risk securitization, risk trading, accelerating asset liability modelling, calculating reserves, projecting cashflows, pricing risk, liability matching and integrating actuarial systems.

In third embodiment, the present disclosure describes an artificial intelligence (AI) based neural imager device configured to evaluate and replicate actuarial calculation patterns. Said device comprising an input interface configured to receive a first input from a data generation unit, a second input from an actuarial assumption generation unit and a third input from a valuation system and at least one processor configured to generate a plurality of untrained network architecture images, by comparing data of the first and the second input with data of the third input. Said device further comprising an assigning unit configured to assign each of the generated untrained network architecture images to at least one processing unit for evaluation, wherein the at least one processing unit evaluates, whether the generated image is within a pre-defined tolerance level and a storage unit configured to store the image that is within a pre-defined tolerance level for future evaluations.

In another embodiment, the present disclosure describes that the at least one processor is configured to generate a plurality of untrained network architecture images until the image within pre-defined tolerance level is achieved.

In another embodiment, the present disclosure describes that the at least one processing unit is a GPU machine resident outside the neural device.

In another embodiment, the present disclosure describes that the at least one processing unit is a GPU machine resident inside the neural device.

In fourth embodiment, the present disclosure describes a non-transitory computer program product. Said product includes a computer-readable medium, wherein the said computer readable medium comprises at least one instruction for generating a first output, in response to random data provided for an actuarial assessment, the first output being in a first format, at least one instruction for generating a second output, in response to at least one of demographic and economic assumptions, the second output being in the first format. The computer readable medium further comprises at least one instruction for receiving the first output and the second output, as inputs, at a valuation system via a valuation system interface, at least one instruction for performing at the valuation system, actuarial calculations on the first output and the second output and at least one instruction for providing by the valuation system, a third output, in response to said calculations, said output being in a second format, wherein the first format is different than the second format. In addition, the computer readable medium comprises at least one instruction for receiving at a neural imager, the first, the second and the third output, as inputs and at least one instruction for evaluating at the neural imager, the first and the second output with the third output to generate at least one image replicating the actuarial calculation patterns of said valuation system wherein said evaluation involves performing iterations, on the first and the second outputs, until the generated image is within pre-defined tolerance level and at least one instruction for storing the generated image for future evaluations.

In another embodiment, the present disclosure describes that the computer readable medium further comprise at least one instruction for converting the first output and the second output in a third format different than the first format and at least one instruction for converting the third output in the third format different than the second format, wherein the third format is a format readable by the neural imager.

In another embodiment, the present disclosure describes that the computer readable medium is executed with one or more valuation systems, wherein each of said valuation systems is capable of interacting with the neural imager at a time.

In another embodiment, the present disclosure describes that said computer readable medium is executed in at least one of establishment of consensus actuarial models, risk securitization, risk trading, accelerating asset liability modelling, calculating reserves, projecting cashflows, pricing risk, liability matching and integrating actuarial systems.

In fifth embodiment, the present disclosure describes an artificial intelligence (AI) based neural imaging system configured to evaluate and replicate actuarial calculation patterns. Said system comprising means for generating a first output, in response to random data provided for an actuarial assessment, the first output being in a first format, means for generating a second output, in response to at least one of demographic and economic assumptions, the second output being in the first format. Said system further comprises a valuation means configured to receive the first output and the second output, as inputs, via a valuation means interface to perform actuarial calculations on the first output and the second output and provide a third output, in response to said calculations, said output being in a second format, wherein the first format is different than the second format. The system further discloses having a neural imaging means configured to receive the first, the second and the third output, as inputs, and evaluate the first and the second outputs with the third output to generate at least one image replicating the actuarial calculation patterns of said valuation system, wherein said evaluation involves performing iterations, on the first and the second outputs, until the generated image is within pre-defined tolerance level and means for storing the generated image for future evaluations.

### BRIEF DESCRIPTION OF DRAWINGS

The novel features and characteristic of the disclosure are set forth in the appended claims. The disclosure itself, however, further objectives and advantages thereof, will best be understood by reference to the following detailed description of an illustrative embodiment when read in conjunction with the accompanying drawings. One or more embodiments are now described, by way of example only, with reference to the accompanying drawings wherein like reference numerals represent like elements and in which:

FIG. 1A shows a neural imaging system, by way of block diagram, working in conjunction with single valuation system to evaluate and replicate actuarial calculation patterns of said valuation system, in accordance with an embodiment of the present disclosure;

FIG. 1B shows a neural imager, by way of block diagram, in accordance with an embodiment of the present disclosure;

FIG. 2 shows a method for evaluating and replicating actuarial calculation patterns of a valuation system, by way of a flow diagram, in accordance with an embodiment of the present disclosure; and

FIG. 3 shows a neural imaging system, by way of block diagram, intended to evaluate and replicate actuarial calculation patterns of a valuation system, using various means, in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

Some embodiments of this invention, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such an item or items or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred systems and methods are now described.

The elements illustrated in the figures inter-operate as explained in more detail below. Before setting forth the detailed explanation, however, it may be noted that all of the discussion below, regardless of the particular implementation being described, is exemplary in nature, rather than limiting.

The techniques described herein may be implemented using one or more computer programs executing on (or executable by) a programmable computer including any combination of any number of the following: a processor, a sensor, a storage medium readable and/or writable by the processor (including, for example, volatile and non-volatile memory and/or storage elements), plurality of input units, plurality of output devices and networking devices.

Each computer program within the scope of the claims below may be implemented in any programming language, such as assembly language, machine language, a high-level procedural programming language, or an object-oriented programming language. The programming language may, for example, be a compiled or interpreted programming language. Each such computer program may be implemented in a computer program product tangibly embodied in a machine-readable storage device for execution by a computer processor.

Method steps as disclosed by the present disclosure may be performed by one or more computer processors executing a program tangibly embodied on a non-transitory computer-readable medium to perform functions of the invention by operating on input and generating output. Suitable processors include, by way of example, both general and special purpose microprocessors. Generally, the processor receives (reads) instructions and content from a memory (such as a read-only memory and/or a random-access memory) and writes (stores) instructions and content to the memory. Storage devices suitable for tangibly embodying computer program instructions and content include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially designed ASICs (Application-Specific Integrated Circuits) or FPGAs (Field-Programmable Gate Arrays).

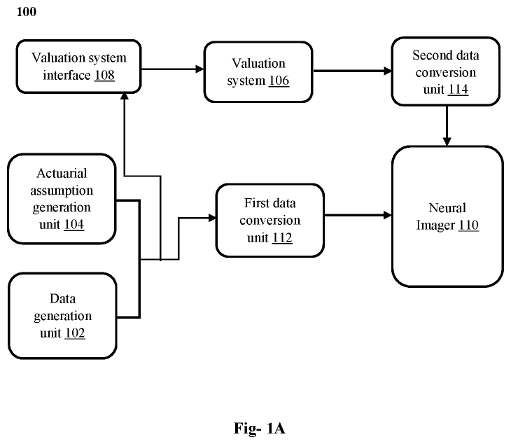

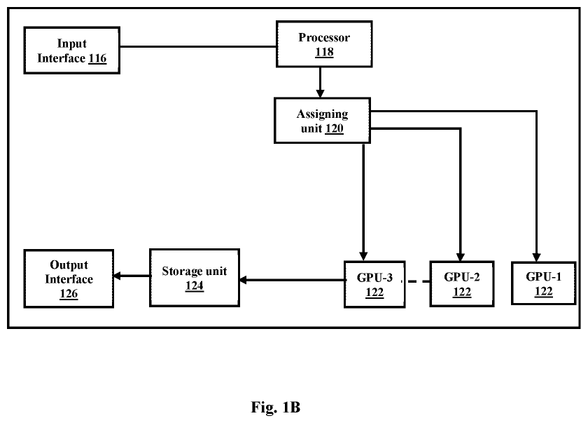

Referring to FIG. 1A, which discloses an artificial intelligence (AI) based neural imaging system 100 that is configured to evaluate and replicate actuarial calculation patterns of a plurality of known actuarial models/valuation systems. The system 100 discloses having a data generation unit 102 configured to generate a first output in response to random data provide for an actuarial assessment. Specifically, the data generation unit 102 may be configured to generate the first output in response to receiving user specifics, the data fields for which random data is to be generated, and the range of possible values.

In an exemplary embodiment, if the system 100 is configured to calculate reserves for a life insurance policy, the user may have to feed randomly generated information on the policy holder into the data generation unit 102. In such an example, the information on the policy holder may include at least on of age, gender and other risk factors such as smoker/non-smoker etc. In an embodiment, the data generation unit 102 may be a separate computing device which may include at least one of a palm top, lap top, mobile device, or any other like computing device. Further, it shall be appreciated that the data generation unit 102 is configured to provide the first output in the first format which is machine readable.

The system 100 further discloses having an actuarial assumption generation unit 104. Said actuarial assumption generation unit 104 may be configured to generate a second output in response to at least one demographic and economic assumptions. Specifically, the actuarial assumption generation unit 102 may be configured to generate the second output in response to receiving user specifics including at least one economic and/or demographic assumption from the user. The second output may be in the first format i.e. similar to the format generated by the data generation unit 102. In an exemplary embodiment, the actuarial assumption generation unit 104 may be a separate computing device which may include at least one of a palm top, lap top, mobile device, or any other like computing device.

In an exemplary embodiment, the present invention may work in a scenario where both the data generation unit 102 and the actuarial assumption generation unit 104 receive inputs and provide their respective outputs. In another exemplary embodiment, present invention may work in a scenario where only the data generation unit 102 receives inputs and not the actuarial assumption generation unit 104.

FIG. 1A further discloses having a valuation system 106 within the system 100. As shown in FIG. 1A, the valuation system 100 may be configured to receive the first output from the data generation unit 102 and the second output from the actuarial assumption generation unit 104 as inputs. In an embodiment, the valuation system 106 may be configured to receive the first output and the second output using a valuation system interface 108. Said valuation system interface 108 may simply serve as a means to automate feeding the demographic and assumption data into the valuation system 106 for performing actuarial calculations. It shall be appreciated that the process of feeding is performed in batches.

Further, in an exemplary embodiment, said valuation system 106 may be any conventional valuation system whose calculation mechanism are to be evaluated and replicated by the system 100. Further, it may be noted that the system 100 may include one or more such valuation systems. Coming back to FIG. 1A, after receiving the first output and the second out, as inputs the valuation system 106 is configured to perform actuarial calculations on the received first output and the second output. To perform these actuarial calculations, the valuation system 106 may use a combination of numerous algorithms, designed to perform calculations for the particular valuation system 106. Further, based on the calculated results, the valuation system 106 is configured to provide a third output which is in a second format, wherein the second format is different than the first format.

In an embodiment, it is to be appreciated that to calibrate valuation system's output for further processing, the likely maximum values of output feels are needed. Therefore, a large volume, in an e.g. one million records are sent, in the form of the first output and the second output from data generation unit 102 and the actuarial assumption generation unit 104 respectively, to the valuation system 106, for performing actuarial calculations, to establish likely maximum values.

As shown in FIG. 1A, said system 100 further discloses having one or more data conversion units. In particular, the system 100 includes a first data conversion unit 112 and a second data conversion unit 114. The first data conversion unit 112 is configured to be operatively coupled to the outputs of the data generation unit 102 and the actuarial assumption generation unit 104 and configured to convert the first output and the second output, received from the data generation unit 102 and the actuarial assumption generation unit 104 respectively, into a third format different than the first format.

Further, as illustrated in FIG. 1A, the second data conversion unit 114 remain operatively coupled at the output of the valuation system 106.

In particular, the second data conversion unit 114 is configured to receive the third output from the valuation system 106 and convert the third output in the third format which is different than the second format of the valuation system 106.

FIG. 1A further discloses that the system 100 also comprises a neural imager 110. The neural imager 110 is an artificial intelligence (AI) based system made up of multiple layers of neural networks designed to recognize patterns distinct to the actuarial calculations. It is to be appreciated that the neural imager 110 is an artificially intelligent (AI) system that works on the principles of machine learning. The details of the neural imager 110 are illustrated in detail in FIG. 1B, however, to understand the working of the neural imager 110 FIG. 1B must be analyzed in conjunction with FIG. 1A. Further, it is stated that the component of the neural imager 110 disclosed in FIG. 1B are simply for the purpose of illustration of the invention. However, the neural imager 110 may include various other essential elements/embodiment as per the requirement and the same shall be construed in limiting sense in anyway.

As shown in FIG. 1A, said neural imager 110 is configured to receive a plurality of outputs, from other units, as inputs. In particular, the neural imager 110 is configured to receive at least one of the first output from the data generation unit 102, the second output from the actuarial assumption generation unit 104 and the third output from the valuation system 106, as inputs. As illustrated in more detail in FIG. 1B, the neural imager 110 may be configured to have an input interface 116 for receiving the first output, the second output and the third output. further, in an embodiment, the input interface 116 may be a hardware port or a wireless interface or a combination or both.

Further, from FIG. 1A it is clear that the neural imager 110 receives the first and the second output, from the data generation unit 102 and the actuarial assumption generation unit 104, via the first data conversion unit 112 respectively. In an exemplary embodiment, the neural imager 110 may be configured to receive the first output and the second output, via the first data conversion unit 112, in multiple formats of data based on various network architectures used by the neural imager 110. In another embodiment, the first data conversion unit 112 may form a part of the neural imager 110 and may not be a separate entity. Those skilled in the art will appreciate, if the first data conversion unit 112 is a part of the neural imager 110 it may be implemented in the form of a hardware, software or a combination thereof. In another embodiment, it is to be noted that the neural imager 110 is configured to evaluate the data when presented to it only in a certain format for example, machine readable in the values of 0 and 1. Therefore, the first data conversion unit 112 is configured to convert each field in the batch of data received from the data generation unit 102 and the actuarial assumption generation unit 104 into single readable format i.e. the third format for the neural imager 110.

Similarly, it is to be appreciated that the third output is received by the neural imager 110 via the second data conversion unit 114. In an exemplary embodiment, the neural imager 110 may be configured to receive the third output, via the second data conversion unit 114, in multiple formats of data based on various network architectures used by the neural imager 110. In another embodiment, the second data conversion unit 114 may form a part of the neural imager 110 and may not be a separate entity. Those skilled in the art will appreciate, if the second data conversion unit 114 is a part of the neural imager 110 it may be implemented in the form of a hardware, software or a combination thereof. Further, similar to the first data conversion unit 112, the second data conversion unit 114 is configured to convert each field in the batch of data received from the valuation system 106 into a machine readable format i.e. the third format for the neural imager 110.

The neural imager 110, disclosed in FIG. 1B, further includes a processor 118 configured to evaluate, the first and the second outputs with the third output to generate at least one image replicating the actuarial calculation patterns of said valuation system 106. In an exemplary embodiment, the neural imager may include plurality of processor 118 configured to perform the step of evaluation, as discussed above. In an embodiment, performing said evaluation involves performing multiple iterations, on the first and the second outputs, until the generated image is within a pre-defined tolerance level. To understand the concept of evaluation in more detail reference may be made to FIG. 1B.

According to an aspect, the processor 118 of the neural imager 110 is configured to generate a series of untrained network architectures for evaluation based on available compute resources and time. In particular, specifications, of untrained network architectures include, number of neural network blocks, size and shape of blocks (# of layers, # of neurons per layer), activation function, learning rates etc. These specifications are often referred to as the hyperparameters by experts skilled in the art. In particular, the processor 118 defines image recognition network architecture and a set of corresponding hyperparameters needed by the image recognition architectures (as shown in FIG. 1B) to capture actuarial patterns. So the processor 118 explores the universe of architecture and hyperparameter combination options to come up with the precise architecture needed to replicate the actuarial patterns under examination. Those skilled in the art of machine learning/neural networks are well-aware of said terminologies and the same are not explained in detail here.

According to another aspect, the neural imager 110 further includes an assigning unit 120 configured to assign each untrained architecture, generated by the processor 118, to a GPU 122. In an exemplary embodiment, the neural imager 110 may include any number of GPU's 122 to make the processing fast. In another embodiment, the GPU 122 may form a part of the neural imager 110 or may be placed outside the neural imager 110, in a separate computing device (not shown). Therefore, if the processor 118 finds out that the resources are limited, a queue process is used. The processor 118 also assigns a maximum training time and minimum required error rate to each GPU 122.

The entire process, when performed by the neural imager 110 for the first time for any valuation system 106, is defined as a training process or the machine learning process, reason being during this process the neural imager 110 evaluates the results from the valuation system 106 and tries to replicate them to a pre-defined tolerance level. In an exemplary embodiment, the results achieved using the neural imager 110 have a pre-defined tolerance level of 0.2%. Further, said process is continued until at least one final image with the pre-defined tolerance level is achieved by the neural imager 110.

In an aspect, during the training process, the processor 118 of the neural imager 110 sends the same batch of input data/neurons and corresponding network specific output neurons to GPU 122. In response, each GPU 122 report progress on errors rates and any failures. In an embodiment, the output received from the GPU 122 is details of the network architecture with the weights to apply to each neuron in each layer to get the desired image. The processor 118 dynamically allocates GPU 122 compute resources based on progress as it searches for acceptable image and once an image within the acceptable tolerance level is found iteration stop. It is to be noted that said image replicates the results of the valuation system 106. Further when connected to actual demographic and actuarial database sources, said image can provide output in the form of individual data records, pie charts, images, bar graphs or any other format understandable by human and the same is not limited to any particular format.

The system 100 further discloses that the neural imager 110 also includes a storage unit 124 for storing the images generated by the processor 118 in combination with the GPU 122. In one aspect, these images can be used for future evaluations without having of the need to the valuation system. Further, the images generated by the neural imager 100 may be presented for human evaluation using an output interface 126.

Those skilled in the art would understand the system 100 disclosed in FIGS. 1A and 1B, may be used to train the neural imager 110 for unlimited number of valuations systems 106. Further, once, the neural imager 110 is trained for a valuation system, the neural imager can simply perform the operations performed by that valuation system or systems on its own. In an aspect the said system 100 may be applied to at least one of establishment of consensus actuarial models, risk securitization, risk trading, accelerating asset liability modelling, calculating reserves, projecting cashflows, pricing risk, liability matching, integrating actuarial systems and like applications.

Additional details with respect to functionalities of the various units disclosed in the system 100 are described in the following paragraphs.

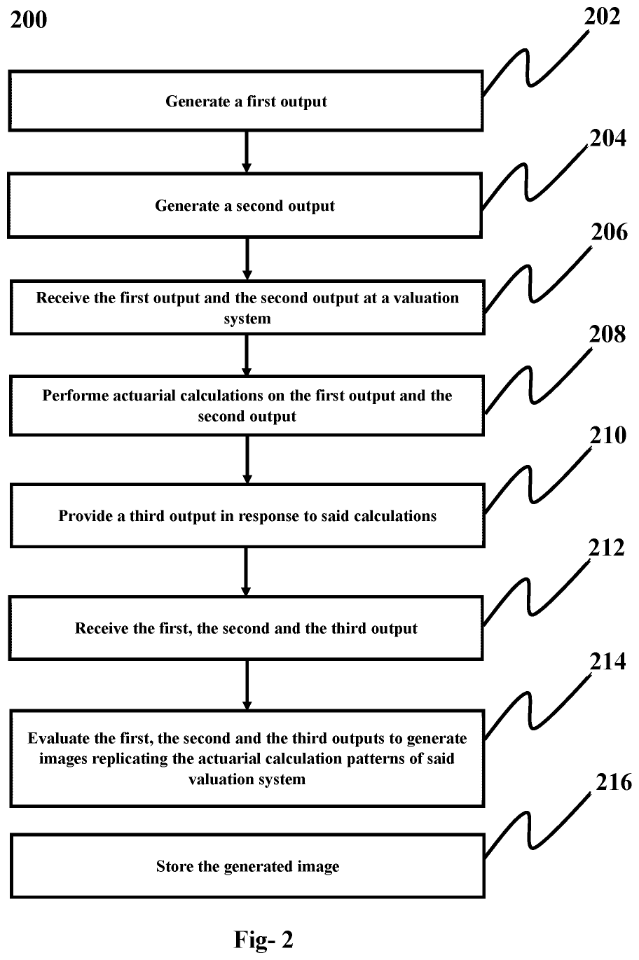

The method 200 of FIG. 2 illustrates, at step 202, generating a first output, in response to random data provided for an actuarial assessment. In an embodiment, the data generation unit 102 is configured to generate the first output in response to receiving random user data, wherein the first output is generated in a first format. In another embodiment, the data generation unit 102 may be configured to generate the first output based on the parameters specified by the user for randomization. At step 204, the method 200 discloses generating a second output, in response to at least one of demographic and economic assumptions. In an aspect, the actuarial assumption generation unit 104 is configured to generate the second output in response to receiving at least one of demographic and economic assumptions. In another aspect, the actuarial assumption generation unit 104 may be configured to generate the second output based on the parameters specified by the user for randomization.

Once, the first and the second outputs are generated, the method moves to step 206, that discloses receiving the first output and the second output at the valuation system 106 via a valuation system interface 108 as inputs. In an aspect, the valuation system 106 may be a bespoke valuation system. At step 208, the method discloses performing at the valuation system, actuarial calculations on the first output and the second output. In an aspect, the valuation system 106 may include multiple algorithms and software's to perform these actuarial calculations. Subsequent to step 208, the method discloses at step 210, providing by the valuation system 106, a third output, in response to said calculations. In an embodiment, the third output may be in a second format, wherein the second format is different than the first format.

At step 212, the method 200 discloses receiving at the neural imager 110, the first, the second and the third output as inputs. In an aspect, prior to step 212, i.e. receiving at the neural imager 110, the first, the second and the third output, the method includes two additional steps. First, converting the first output and the second output in a third format different than the first format, wherein said step of converting is performed using the first data conversion unit 112. Second, converting the third output in the third format different than the second format, wherein said step of converting is performed using the second data conversion unit 114. Those, skilled in the art will appreciate that the first data conversion unit 112 and the second data conversion unit 114 do not only serve the purpose of feeding the first, the second and the third outputs, as inputs, to the neural imager 110, but they also convert these data in the third format, understandable by the neural imager 110.

As the next step 214, the method 200 discloses evaluating at the neural imager 110, the first and the second outputs with the third output to generate at least one image replicating the actuarial calculation patterns of said valuation system 106, wherein said evaluation involves performing iterations, on the first and the second outputs, until the generated image is within pre-defined tolerance level. The process of evaluation, discussed at step 214, can be understood in more detail from the below paragraphs.

According to an aspect, the process of evaluation starts with the processor 118, of the neural imager 110, generating a series of untrained network architectures for evaluation based on available compute resources and time. In particular, specifications, of untrained network architectures, include, number of neural network blocks, size and shape of blocks (# of layers, # of neurons per layer), activation function, learning rates etc.

As the next step of evaluation, the neural imager 110 discloses assigning by an assigning unit 120 each untrained architecture, generated by the processor 118, to a GPU 122. In an exemplary embodiment, the neural imager 110 may include any number of GPU's 122 to make the processing fast. In another embodiment, the GPU 122 may form a part of the neural imager 110 or may be placed outside the neural imager 110, in a separate computing device (not shown). Therefore, if the processor 118 finds out that the resources are limited, a queue process is used. The processor 118 is also configured to assign a maximum training time and minimum required error rate to each GPU 122.

In an aspect, it is submitted that the entire method, when performed by the neural imager 110 for the first time for any valuation system 106, is defined as a training process or the machine learning process, reason being during this process the neural imager 110 evaluates the results from the valuation system 106 and tries to replicate them to produce an image with a pre-defined tolerance level. In an exemplary embodiment, the results achieved using the neural imager 110 have a pre-defined tolerance level of 0.2%. Further, said process is continued until at least one final image with the pre-defined tolerance level is achieved by the neural imager 110.

As the next step, in the method of evaluation, the processor 118 of the neural imager 110 is configured to send the same batch of input data/neurons and corresponding network specific output neurons to GPU 122. In response, each GPU 122 reports progress on errors rates and any failures. In an embodiment, the output received from the GPU 122 is details of the network architecture with the weights to apply to each neuron in each layer to get the desired image. Further, in an aspect, the processor 118 dynamically allocates GPU 122 compute resources based on progress as it searches for acceptable image and once an image within the acceptable tolerance level is found iteration stop. It is to be noted that said image replicates the results of the valuation system 106. Further, when connected to actual demographic and actuarial database sources, said image can provide output in the form of individual data records, pie charts, images, bar graphs or any other format understandable by human and the same is not limited to any particular format.

Once, the image within the pre-defined tolerance level is achieved, as discussed above, the method moves towards step 216. Particularly, at step 216 the method discloses storing the generated image in the storage unit 124 for future evaluations. In one aspect, the images, generated by using the steps of method 200 may be used for future evaluations without having a need of the valuation system. Further, the images generated by the neural imager 100 may be presented for human evaluation using an output interface 126.

Those skilled in the art would understand the method 200 disclosed in FIG. 2, may be used to train the neural imager 110 for unlimited number of valuations systems 106. Further, once, the neural imager 110 is trained for a valuation system, the neural imager 110 can simply perform the operations performed by that valuation system on its own. In an aspect the said method may be applied to at least one of establishment of consensus actuarial models, risk securitization, risk trading, accelerating asset liability modelling, calculating reserves, projecting cashflows, pricing risk, liability matching, integrating actuarial systems and like applications.

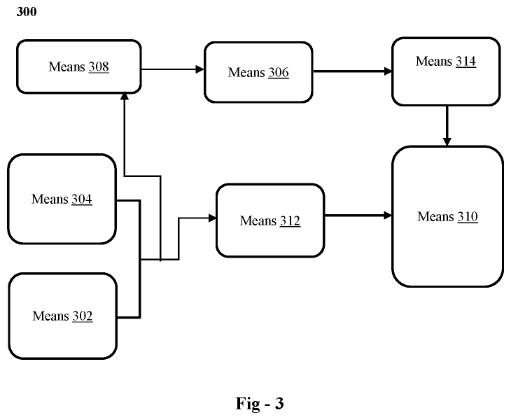

The various operations of methods described above may be performed by any suitable means capable of performing the corresponding functions as shown in FIG. 3. The means may include various hardware and/or software components) and/or module(s), including, but not limited to a circuit, an application specific integrated circuit (ASIC), or processor. For example, means 302 for generating a first output, means 304 for generating a second output and the means 306 for generating a third output may comprise a processor, an ASIC, a microprocessor a microcontroller or any similar hardware, software or a combination thereof. Further, the means 306 for valuation may comprise a separate computer platform, a processor, an ASIC, a microprocessor a microcontroller or any similar hardware, software or a combination thereof. Similarly, the neural imaging means 310 may comprise a computer platform, a processor, an ASIC, a microprocessor a microcontroller or any similar hardware, software or a combination thereof. Further each of these means 302-314 may include various capabilities such as receiving and transmitting data through various means and processing the data through various means.

In one or more exemplary designs, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A. storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While various aspects and embodiments have been disclosed herein, other aspects and embodiments will be apparent to those skilled in the art. It may be pertinent to note that various aspects and embodiments disclosed herein are for purposes of illustration and are not intended to be limiting, with the true scope being indicated by the following claims.

Reference Numerals:

| Reference | |
|---|---|
| numbers | Description |
| 100 | Artificial intelligence (AI) based neural imaging system |
| 102 | Data generation unit |
| 104 | Actuarial assumption generation unit |
| 106 | Valuation system |
| 108 | Valuation system interface |
| 110 | Neural Imager |
| 112 | First data conversion unit |
| 114 | Second data conversion unit |
| 116 | Input interface |
| 118 | Processor |
| 120 | Assigning unit |
| 122 | General purpose processor |
| 124 | Storage unit |
| 126 | Output interface |
| 200 | Method |
| 202-216 | Method Steps |
| 300 | Artificial intelligence (AI) based neural imaging system |
| 302-314 | Various means of artificial intelligence (AI) based neural |
| | imaging system |

1. An artificial intelligence (AI) based neural imaging system configured to evaluate and replicate actuarial calculation patterns, the system comprising:
a data generation unit configured to generate a first output, in response to random data provided for an actuarial assessment, the first output being in a first format;
an actuarial assumption generation unit configured to generate a second output, in response to receiving at least one of demographic and economic assumptions, the second output being in the first format;
a bespoke valuation system configured to:
receive the first output and the second output via a valuation system interface as inputs;
perform actuarial calculations on the first output and the second output; and
provide a third output, in response to said calculations, said output being in a second format, wherein the first format is different than the second format; and
a neural imager configured to:
receive the first, the second and the third output as inputs;
evaluate, the first and the second outputs with the third output to generate at least one image replicating the actuarial calculation patterns of said valuation system, wherein the neural network involves performing iterations, on the first and the second outputs, using plurality of GPU's, until the generated image is within pre-defined tolerance level; and
store the generated image for future evaluations

2. The system as claimed in claim 1, further comprising:
a first data conversion unit coupled to the data generation unit and the actuarial assumption generation unit, the first data conversion unit configured to convert the first output and the second output in a third format different than the first format; and
a second data conversion unit coupled to the valuation system, the second data conversion unit configured to convert the third output in the third format different than the second format, wherein the third format is a format readable by the neural imager.

3. The system as claimed in claim 1, wherein the neural imager receives the first output and the second output via the first data conversion unit.

4. The system as claimed in claim 1, wherein the neural imager receives the third output via the second data conversion unit.

5. The system as claimed in claim 1, includes one or more valuation systems, wherein each of said valuation systems is capable of interacting with the neural imager at a time.

6. The system as claimed in claim 1, is applied in at least one of establishment of consensus actuarial models, risk securitization, risk trading, accelerating asset liability modelling, calculating reserves, projecting cashflows, pricing risk, liability matching and integrating actuarial systems.

7. A method of training an artificial intelligence (AI) based neural imaging system for evaluating and replicating actuarial calculation patterns, the method comprising:
generating a first output, in response to random data provided for an actuarial assessment, the first output being in a first format;
generating a second output, in response to at least one of demographic and economic assumptions, the second output being in the first format;
receiving the first output and the second output at a bespoke valuation system via a valuation system interface as inputs;
performing at the valuation system, actuarial calculations on the first output and the second output; and
providing by the valuation system, a third output, in response to said calculations, said output being in a second format, wherein the first format is different than the second format;
receiving at a neural imager, the first, the second and the third output as inputs;
evaluating at the neural imager, the first and the second outputs with the third output to generate at least one image replicating the actuarial calculation patterns of said valuation system, wherein the neural network involves performing iterations, on the first and the second outputs, using plurality of GPU's, until the generated image is within pre-defined tolerance level; and
storing the generated image for future evaluations.

8. The method as claimed in claim 7, further comprising:
converting the first output and the second output in a third format different than the first format; and
converting the third output in the third format different than the second format, wherein the third format is a format acceptable to the neural imager.

9. The method as claimed in claim 7, wherein the first output, the second output and the third output are received by the neural imager in the third format.

10. The method as claimed in claim 7, is performed with one or more valuation systems, wherein each of said valuation systems is capable of interacting with the neural imager at a time.

11. The method as claimed in claim 7, is applied in at least one of establishment of consensus actuarial models, risk securitization, risk trading, accelerating asset liability modelling, calculating reserves, projecting cashflows, pricing risk, liability matching and integrating actuarial systems.

12. An artificial intelligence (AI) based neural imager device configured to evaluate and replicate actuarial calculation patterns, the device comprising:
an input interface configured to receive a first input from a data generation unit, a second input from an actuarial assumption generation unit and a third input from a valuation system;
at least one processor configured to generate a plurality of untrained network architecture images, by comparing data of the first and the second input with data of the third input;
an assigning unit configured to assign each of the generated untrained network architecture images to at least one processing unit for evaluation, wherein the at least one processing unit evaluates, whether the generated image is within a pre-defined tolerance level; and
a storage unit configured to store the image that is within a pre-defined tolerance level for future evaluations.

13. The device as claimed in claim 12, wherein the at least one processor is configured to generate a plurality of untrained network architecture images until the image within pre-defined tolerance level is achieved.

14. The device as claimed in claim 12, wherein the at least one processing unit is a GPU machine resident outside the neural device.

15. The device as claimed in claim 12, wherein the at least one processing unit is a GPU machine resident within the neural device.

16. A non-transitory computer program product, comprising:
a computer-readable medium, comprising:
at least one instruction for generating a first output, in response to random data provided for an actuarial assessment, the first output being in a first format;
at least one instruction for generating a second output, in response to at least one of demographic and economic assumptions, the second output being in the first format;
at least one instruction for receiving the first output and the second output, as inputs, at a valuation system via a valuation system interface;
at least one instruction for performing at the valuation system, actuarial calculations on the first output and the second output; and
at least one instruction for providing by the valuation system, a third output, in response to said calculations, said output being in a second format, wherein the first format is different than the second format;
at least one instruction for receiving at a neural imager, the first, the second and the third output as inputs;
at least one instruction for evaluating at the neural imager, the first and the second output with the third output to generate at least one image replicating the actuarial calculation patterns of said valuation system wherein the neural network involves performing iterations, on the first and the second outputs, using plurality of GPU's, until the generated image is within pre-defined tolerance level; and
at least one instruction for storing the generated image for future evaluations.

17. The non-transitory computer program product as claimed in claim 16, further comprising:
at least one instruction for converting the first output and the second output in a third format different than the first format; and
at least one instruction for converting the third output in the third format different than the second format, wherein the third format is a format readable by the neural imager.

18. The non-transitory computer program product as claimed in claim 16, wherein the computer readable medium is executed with one or more valuation systems, wherein each of said valuation systems is capable of interacting with the neural imager at a time.

19. The non-transitory computer program product as claimed in claim 16, wherein the computer readable medium is executed in at least one of establishment of consensus actuarial models, risk securitization, risk trading, accelerating asset liability modelling, calculating reserves, projecting cashflows, pricing risk, liability matching and integrating actuarial systems.

20. An artificial intelligence (AI) based neural imaging system configured to evaluate and replicate actuarial calculation patterns, the system comprising:
means for generating a first output, in response to random data provided for an actuarial assessment, the first output being in a first format;
means for generating a second output, in response to at least one of demographic and economic assumptions, the second output being in the first format;
a bespoke valuation means configured to:
receive the first output and the second output via a valuation means interface as inputs;
perform actuarial calculations on the first output and the second output; and
provide a third output, in response to said calculations, said output being in a second format, wherein the first format is different than the second format; and
a neural imaging means configured to:
receive the first, the second and the third output as inputs;
evaluate, the first and the second outputs with the third output to generate at least one image replicating the actuarial calculation patterns of said valuation system, wherein the neural network means involves performing iterations, on the first and the second outputs, using plurality of GPU's, until the generated image is within pre-defined tolerance level; and
means for storing the generated image for future evaluations.
